(19) United States
(12) Patent Application Publication
(10) Pub. No.: US 2026/0189088 A1
(43) Pub. Date: Jul. 2, 2026

(54) ROTOR OF AN ELECTRIC MACHINE

(71) Applicant: Robert Bosch GmbH, Stuttgart (DE)

(72) Inventor: Dominik Flore, Schwieberdingen (DE)

(21) Appl. No.: 18/877,711

(22) PCT Filed: May 22, 2023
(86) PCT No.: PCT/EP2023/063612

§ 371 Date: Dec. 20, 2024

(30) Foreign Application Priority Data
Jun. 28, 2022 (DE) 10 2022 206 513.1

(51) Int. Cl. H02K 1/276; H02K 1/32; H02K 7/00

(52) U.S. Cl. CPC H02K 1/276; H02K 1/32; H02K 7/003

(57) ABSTRACT

A rotor (1) of an electric machine, with a rotor carrier (3), a rotor body (4) disposed on the rotor carrier (3) and a rotor sleeve (5) enclosing the rotor body (4), wherein the rotor body (4) comprises an internal passage (6) for inserting the rotor carrier (3) and a plurality of rotor poles (7), wherein at least one of the rotor poles (7) comprises a magnetic layer (8) of a plurality of magnets (9), wherein the respective rotor pole (7) is divided by the magnetic layer (8) in the radial direction into an inner pole segment (10) and an outer pole segment (11), wherein a magnetic pocket (12) is formed in each of the respective rotor poles (7) between the outer pole segment (11) and the inner pole segment (10), which is provided for receiving the magnets (9) of the magnetic layer (8) and comprises a central area (12.1), which is designed without bridges, wherein each respective magnetic pocket (12) comprises two pocket legs (12.2), wherein an axial cooling channel (15) is provided at each of the pole edges (7.2) of the rotor poles (7), which is arranged between two pocket legs (12.2) of two adjacent magnetic pockets (12), wherein the rotor body (4) radially within the cooling channels (15) has a hub portion (4.2), wherein the rotor sleeve (5) is pre-tensioned, characterized in that the hub section (4.2) comprises a plurality of radial breaker slots (16) along its extension in the circumferential direction, each opening into one of the cooling channels (15), and that the pre-tensioning of the rotor sleeve (5) is generated or increased by a radially outward acting tension of the inner pole segments (10) against the rotor sleeve (5).

### BACKGROUND

The invention proceeds from a rotor of an electric machine.

A rotor of an electric machine is already known from WO21225902 A1 is already known, having a rotor shaft rotatable about a rotor axis, a rotor body disposed on the rotor shaft, in particular a rotor plate package, and a rotor sleeve enclosing the rotor body, wherein the rotor body comprises an internal passage for inserting the rotor shaft and a plurality of rotor poles each having a pole center, wherein a V-shaped magnetic layer of two magnets, in particular permanent magnets, is configured in all rotor poles, wherein the respective rotor pole is divided by the magnetic layer in a radial direction with respect to the rotor axis into an inner pole segment and an outer pole segment, wherein a magnetic pocket is formed in the respective rotor pole between the outer pole segment and the inner pole segment, which is provided for receiving the magnets of the magnetic layer and comprises a central region, which lies in particular in the area of the pole center and is configured without a bridge, wherein each of the respective magnetic pockets comprises two pocket legs, which are provided for receiving the magnets and are arranged on opposite sides with respect to the pole center, wherein an axial cooling channel is provided at pole edges of the rotor poles, which is arranged between two pocket legs of two adjacent magnetic pockets, wherein the rotor body radially within the cooling channels comprises an annular hub portion, which is provided for mechanical coupling to the rotor carrier, wherein the rotor sleeve is pre-tensioned for clamping the magnets into the magnetic pockets. The rotor sleeve is a wound fiber composite sleeve that is either wound directly onto the rotor body or joined onto the rotor body as a pre-assembled rotor sleeve. In the case of a directly wound fiber composite sleeve, the fibers of the fiber composite sleeve are wound directly onto the rotor body in a winding process under tensile stress. It is disadvantageous for the directly wound fiber composite sleeve that the pre-tensioning of the rotor sleeve must be applied solely by the fibers of the fiber composite sleeve, because the composite material of the fiber composite sleeve has not yet cured during the winding process. The pre-tension which can be produced with the directly wound fiber composite sleeve is therefore limited, so that the fiber composite sleeve must be made comparatively thick. This results in a comparatively large air gap between rotor and stator and a reduction in maximum torque.

The pre-assembled rotor sleeve with cured composite material requires mechanical machining of the laminated rotor body at the comparatively uneven outer circumference in preparation for the joining of the rotor sleeve to the rotor body, which increases manufacturing costs.

### SUMMARY

In contrast, the rotor of an electric machine according to the invention has the advantage that the pre-tensioning in the rotor sleeve and subsequently the pre-tensioning of the magnets in the magnet pockets can be carried out more simply and inexpensively.

According to the present invention, this is achieved by the hub section having a plurality of radial breaker slots along its extension in the circumferential direction, each of which opens up into one of the cooling channels. In addition, the pre-tensioning of the rotor sleeve is generated or increased by a tension of the inner pole segments acting radially outwardly against the rotor sleeve, in particular by pressing the rotor carrier into the inner passageway of the rotor body. The breaker slots according to the invention mechanically decouple the inner pole segments from each other in the radially inner region and thereby allow for the tension of the inner pole segments acting from radially inwardly to radially outward against the rotor sleeve.

According to the present invention, a higher pre-tension of the rotor sleeve can be produced than in the prior art, since the fibers in the cured fiber composite can be loaded with a higher level of tension than the fibers in the uncured fiber composite of the prior art. This allows the rotor sleeve to be made thinner in the radial direction so that the maximum torque of the electric machine can be increased. The rotor carrier can be pressed into the rotor body to pre-tension the rotor sleeve in manufacturing in a shorter time than the winding and curing of the rotor sleeve which occur directly on the rotor body in the prior art. Manufacturing costs can thus be significantly reduced.

It is particularly advantageous if the respective cooling channel is arranged with respect to the radial layer and/or the cross-section and/or the cross-sectional shape in such a way that two rotor spokes are formed between the cooling channel and the two pocket legs of the adjacent magnetic pockets, the longitudinal extension of each of the spokes being respectively larger, in particular multiple times larger, than their width transverse to the longitudinal extension and the spokes being able to be bent to clamp the magnet. In this way, a high level of pre-tension may be produced in the rotor sleeve, thereby achieving a high rotational strength of the rotor and good clamping of the magnets.

It is further advantageous if the respective cooling channel has a radially outermost extension that extends in the radial direction to the radially innermost edges of the magnets of the respective adjacent magnetic pockets or beyond. In this way, rotor spokes are produced with a large longitudinal extension, resulting in a large lever arm for generating the mechanical pre-tension. This flexible construction can be used to produce a high level of deformation and thus a high level of mechanical pre-tension.

Furthermore, is advantageous when the central area of the magnetic pockets each comprises a pocket projection that bends from the pocket legs of the respective magnetic pocket and extends radially inward. In this way, rotor spokes are produced with a large longitudinal extension, resulting in a large lever arm for generating the mechanical pre-tension.

It is very advantageous if the circumferential extension of the respective cooling channel extends radially inward, in particular because the cross section of the cooling channel is triangular, V-shaped, trapezoidal, bell-shaped. This produces sufficiently pliable rotor spokes. For example, the rotor spokes may become narrower radially in the inward direction.

It is also advantageous if an interference fit is provided between the inner passage of the rotor body and the rotor carrier so that the inner passage of the rotor body is widened when the rotor carrier is assembled, whereby the inner pole segments are tensioned against the magnets in the radial direction and against the rotor sleeve, in particular. In this way, the pre-tension in the rotor sleeve can be produced subsequently by the rotor carrier, for example by pressing in the rotor carrier axially. The rotor sleeve may be made thinner due to the cured composite material, so that the maximum torque of the electric machine may be increased. The joining connection between the rotor carrier and the rotor body can be made more easily than a joining connection between a pre-assembled fiber composite sleeve and a rotor body in the prior art, since it comprises two steel components as joining partners and not two different joining partners, and in particular it comprises no fiber composite as a joining partner. The high pre-tension in the rotor sleeve makes it possible for the pole outer segments to lie very close to the respective inner pole segment, so that very small air gaps are present in the magnetic pockets. Therefore, the maximum torque of the electric machine may be further increased.

Advantageously, the rotor body can have a flat section on the outer circumference in the area of each of the pole edges prior to the assembly of the rotor carrier, wherein each flat section lies against the inner circumference of the rotor sleeve through the assembly of the rotor carrier. In this way, a nearly cylindrical outer circumference of the rotor body can be produced in the deformed state so that a homogeneous tension distribution is achieved in the rotor sleeve. This allows for a higher rotor strength and thus a higher maximum speed.

Furthermore, it is advantageous if the respective cooling channel is arranged with a partial cross section in the one rotor pole and with the remaining partial cross section in the respective adjacent rotor pole. This produces sufficiently pliable rotor spokes.

According to an advantageous embodiment, each respective outer pole segment can be connected to the pole inner segment of the same rotor pole by means of bridges that lie on the outer circumference of the rotor body or can each be embodied as a separate pole body.

In addition, is advantageous if the rotor carrier is the rotor shaft, wherein the rotor shaft is a hollow shaft comprising a shaft cooling channel, wherein the respective cooling channel of the rotor body is connected to the flow through the shaft cooling channel via the respective breaker slot and a radial opening of the rotor shaft. In this way, the breaker slot additionally forms a flow connection to the shaft cooling channel so that a cooling medium, for example oil, can be conducted into the cooling channels of the rotor via the shaft cooling channel, the radial openings and the breaker slots for cooling the rotor.

In addition, it is advantageous if the rotor sleeve is a fiber composite sleeve comprising a fiber winding, in particular of glass fiber or carbon fiber, and a cured composite material for embedding the fiber winding. For example, the fiber composite sleeve can be pre-assembled and mounted in the cured state without joining forces, in particular without pressing in the axial direction onto the rotor body. In the case of a pre-assembled rotor sleeve, the outer circumference of the rotor body does not need to be mechanically machined in order to prepare for the joining of the rotor sleeve, in contrast to the prior art, since the pressing is only produced after a force-free joining of the rotor sleeve and the rotor body by pressing the rotor carrier into the rotor body. Alternatively, the fiber winding of the fiber composite sleeve can be wound directly on the rotor body with a very low pre-tension, the applied composite material can be cured on the rotor body, and the pre-tension in the rotor sleeve can be subsequently generated by the axial pressing of the rotor carrier.

The invention also relates to an electric machine comprising a rotor according to the invention.

### BRIEF DESCRIPTION OF THE DRAWINGS

An exemplary embodiment of the invention is shown in simplified form in the drawing and explained in more detail in the following description.

FIG. 1 shows a sectional partial view of a rotor according to the invention of an electric machine, and

FIG. 2 a detail view of a specific embodiment of the rotor body of FIG. 1 prior to assembly of the rotor carrier.

### DETAILED DESCRIPTION

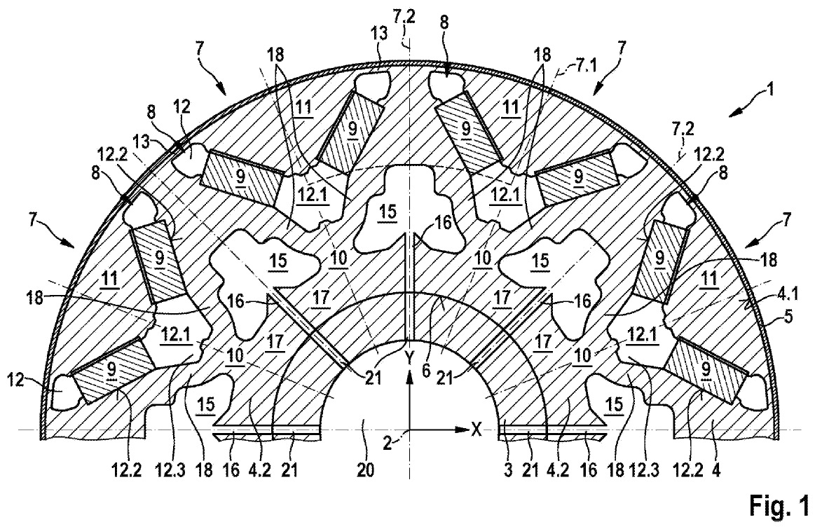

FIG. 1 shows a sectional partial view of a rotor according to the invention of an electric machine.

The rotor 1 of an electric machine 1 according to the invention comprises a rotor carrier 3 which can be rotated about a rotor axis 2, in particular a rotor shaft, a rotor body 4 arranged on the rotor carrier 4, in particular a rotor plate package, and a rotor sleeve 5 surrounding the rotor body 4 on the outer circumference 4.1, in particular a fiber composite sleeve. The rotor body 4 has an internal passage 6 for inserting the rotor carrier 3 and a plurality of rotor poles 7 each having a pole center 7.1. A V-shaped, C-shaped or arc-shaped magnetic layer 8 is formed in at least one, in particular all, of the rotor poles 7 by a plurality of magnets 9, in particular permanent magnets. The respective rotor pole 7 is divided by the respective magnetic layer 8 in a radial direction with respect to the rotor axis 2 into an inner pole segment 10 and an outer pole segment 11. In the respective rotor pole 7, a magnetic pocket 12 is formed between the respective outer pole segment 10 and the respective inner pole segment 11, which is provided for receiving the magnets 9 of the magnetic layer 8 and has a central area 12.1, which is in particular in the area of the pole center 7.1 and is configured without bridges. “Without bridges” means that no bridge is arranged in the central area 12.1 for bridging the magnetic pocket 12 or for connecting the outer pole segment 10 with the inner pole segment 11 of the respective rotor pole 7. The central region 12.1 is formed between two magnets 9 facing the pole center 7.1, for example. The magnets 9 may be coated with an insulation. Alternatively or additionally, a separate insulation can be provided between each magnet 9 and inner pole segment 10 and/or between each magnet 9 and outer pole segment 11.

Each respective outer pole segment 11 can be connected to the inner pole segment 10 of the same rotor pole 7 by means of bridges 13 that lie on the outer circumference 4.1 of the rotor body 4. Alternatively, the outer pole segments 11 can be designed as separate pole bodies by omitting the bridges 13. The outer pole segments 11 can comprise a further magnetic pocket, not shown, for receiving at least one further magnet.

Each of the respective magnetic pockets 12 has two pocket legs 12.2, which are provided for receiving the magnets 9 and are arranged on opposite sides with respect to the pole center 7.1, in particular in a mirrored symmetrical manner with respect to the pole center 7.1.

Each of the rotor poles 7 is formed between two pole edges 7.2 in the circumferential direction with respect to the rotor axis 2. The pole edges 7.2 are also referred to as the q-axis.

An axial cooling channel 15 is provided at each of the pole edges 7.2 of the rotor poles 7, which is arranged between two pocket legs 12.2 of two adjacent magnetic pockets 12 and extends through the rotor body 4 at least in sections in the axial direction relative to the rotor axis 2. Each respective cooling channel 15 is arranged with a partial cross section in the one rotor pole 7 and with the remaining partial cross section in the respective adjacent rotor pole 7.

The rotor body 4 has a hub section 4.2 radially within the cooling channels 15, which is configured for mechanical coupling, i.e. torque transfer, with the rotor carrier 3.

The rotor sleeve 5 has a mechanical pre-tension, in particular for clamping the magnets 9 in the magnetic pockets 12 or in order to have no air gaps if possible, or only small air gaps in the magnetic pockets 12 in the direction of the magnetic flux.

According to the invention, it is provided that the hub section 4.2 comprises a plurality of radial breaker slots 16 along its circumferential direction, which each extend from an inner circumference of the hub section 4.2 facing the rotor carrier 3 in the radial direction and open up into or lead into one of the cooling channels 15. Furthermore, according to the invention, it is provided that the pre-tensioning of the rotor sleeve 5 is generated or increased by a radially outwardly acting tension of the inner pole segments 10 against the rotor sleeve 5, in particular by pressing the rotor carrier 3 into the inner passage 6 of the rotor body 4. The hub portion 4.2 of the rotor body 4 is divided or separated by the breaker slots 16 into ring sections 17. Each of the breaker slots 16 are on or near one of the pole edges 7.2 of the rotor poles 7, for example.

With regard to the radial layer and/or the cross-sectional section and/or the cross-sectional shape, the respective cooling channel 15 is arranged such that two rotor spokes 18 are formed between the cooling channel 15 and the two pocket legs 12.2 of the adjacent magnetic pockets 12, the longitudinal extension of which L is respectively larger, in particular multiple times larger, than their width B transverse to the longitudinal extension L and which can be bent in order to clamp the magnet 9. For example, a cross-sectional side of the respective cooling channel 15 facing the respective rotor spoke 18 forms the length of the respective rotor spoke 18.

The respective cooling channel 15 can have a radially outermost extension that extends in the radial direction to or beyond the radially innermost edges of the magnets 9 of the respective adjacent magnetic pockets 12. Further, the central area 12.1 of each of the magnetic pockets 12 can have a pocket projection 12.3 that bends from the pocket legs 12.2 of the respective magnetic pocket 12 and extends radially inwardly.

The extension of the respective cooling channel 15 in the circumferential direction can extend in the radially inward direction, for example by the cross section of the cooling channel 15 being triangular, V-shaped, trapezoidal or bell-shaped and being aligned accordingly.

An interference fit is provided between the inner passage 6 of the rotor body 4 and the rotor carrier 3, such that the inner passage 6 of the rotor body 4 is widened during assembly of the rotor carrier 3, whereby the inner pole segments 10 are tensioned against the magnets 9 and against the rotor sleeve 5 due to the deformation, in particular the bending of the rotor spokes 18 and/or due to the radial displacement of the inner pole segments 10. For example, the rotor carrier 3 is pressed in the axial direction into the inner passage 6 of the rotor body 4. In addition to the press-fit connection between the rotor body 4 and the rotor carrier 3, a positive-locking joining connection can be provided.

The rotor sleeve 5 is, for example, a fiber composite sleeve comprising a fiber winding, in particular of glass fiber or carbon fiber, and a cured composite material for embedding the fiber winding.

The rotor shaft 3 may be a hollow shaft comprising a shaft cooling channel 20, wherein the respective cooling channel 15 of the rotor body 4 is connected to the flow through the shaft cooling channel 20 via the respective breaker slot 16 and a radial opening 21 in the rotor shaft 3.

After the rotor carrier 3 is pressed in and the rotor sleeve 5 is pre-tensioned, an additional casting compound can optionally be added to the magnetic pockets 12.

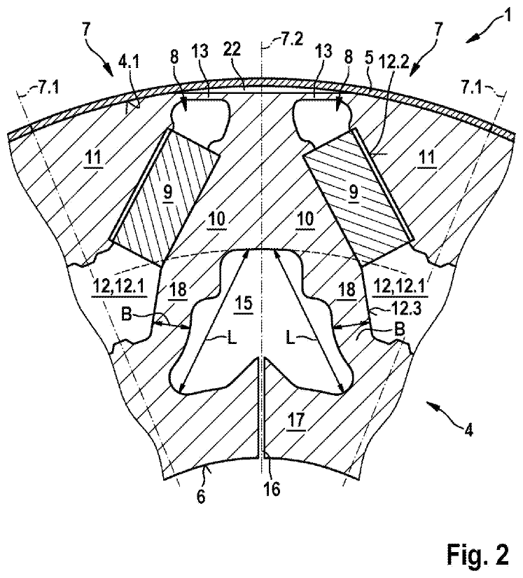

FIG. 2 shows a detail view of a specific embodiment of the rotor body of FIG. 1 prior to assembly of the rotor carrier.

Each rotor body 4 can have a flat section 22 on the outer circumference 4.1 in the area of the pole edges 7.3 prior to the assembly of the rotor carrier 3, which is caused to lie against the inner circumference of the rotor sleeve 5 by the assembly of the rotor carrier 3, which causes the bridges 13 to deforms and moves the respective inner pole segment 10 radially.

1. A rotor (1) of an electric machine, having a rotor carrier (3) rotatable about a rotor axis (2), a rotor body (4) disposed on the rotor carrier (3), and a rotor sleeve (5) enclosing the rotor body (4), wherein the rotor body (4) comprises an inner passage (6) for inserting the rotor carrier (3) and a plurality of rotor poles (7) each having a pole center (7.1), wherein in at least one of the rotor poles (7) a V-shaped, C-shaped or arc-shaped magnetic layer (8) of a plurality of magnets (9) is formed, wherein the respective rotor pole (7) is divided by the magnetic layer (8) in a radial direction with respect to the rotor axis (2) into an inner pole segment (10) and an outer pole segment (11), wherein a magnetic pocket (12) is formed in each of the respective rotor poles (7) between the outer pole segment (11) and the inner pole segment (10), which is provided for receiving the magnets (9) of the magnetic layer (8) and comprises a central area (12.1), wherein each of the respective magnetic pockets (12) comprises two pocket legs (12.2), that are arranged on opposite sides with respect to the pole center (7.1), wherein an axial cooling channel (15) is provided at pole edges (7.2) of the rotor poles (7), which is arranged between two pocket legs (12.2) of two adjacent magnetic pockets (12), wherein the rotor body (4) radially within the cooling channels (15) has a hub section (4.2), which is provided for mechanical coupling to the rotor carrier (3), wherein the rotor sleeve (5) is pre-tensioned, wherein
the hub portion (4.2) comprises a plurality of radial breaker slots (16) along its circumferential extension, each opening up into one of the cooling channels (15), the pre-tensioning of the rotor sleeve (5) is generated or increased by a tension of the inner pole segments (10) acting radially in an outward direction against the rotor sleeve (5).

2. The rotor according to claim 1, wherein the respective cooling channel (15) is arranged in terms of a radial layer and/or a cross-section and/or a cross-sectional shape, wherein between the cooling channel (15) and the two pocket legs (12.2) of adjacent magnetic pockets (12) two rotor spokes (18) are formed, whose longitudinal extension (L) is respectively larger than their width (B) transverse to the longitudinal extension (L) and flexible for the clamping of the magnets (9).

3. The rotor according to claim 1, wherein the respective cooling channel (15) has a radially outermost extension, which extends in the radial direction to radially innermost edges of the magnets (9) of respective adjacent magnetic pockets (12) or beyond.

4. The rotor according to claim 1, wherein the central area (12.1) of each of the magnetic pockets (12) comprises a pocket projection (12.3) that bends off the pocket legs (12.2) of the magnetic pocket (12) and extends radially inward.

5. The rotor according to claim 1, wherein an extension of the respective cooling channel (15) extends radially inward in a circumferential direction.

6. The rotor of according to claim 1, wherein an interference fit is provided between the inner passage (6) of the rotor body (4) and the rotor carrier (3), such that the inner passage (6) of the rotor body (4) is flared during assembly of the rotor carrier (3), whereby the inner pole segments (10) are tensioned in the radial direction against the magnets (9) and against the rotor sleeve (5) due to deformation of the rotor spokes (18) and/or under radial displacement of the inner pole segments (10).

7. The rotor according to claim 1, wherein each of the rotor bodies (4) has a flat section (22) on an outer circumference (4.1) in an area of the pole edges (7.2) prior to assembly of the rotor carrier (3) which lies against an inner circumference of the rotor sleeve (5) through assembly of the rotor carrier (3).

8. The rotor according to claim 1, wherein the respective cooling channel (15) is arranged with a partial cross section in one rotor pole (7) and with a remaining partial cross section in a respective adjacent rotor pole (7).

9. The rotor according to claim 1, wherein a respective pole outer segment (11) is connected to the inner pole segment (10) of the same rotor pole (7) by bridges (13), which lie on an outer circumference (4.1) of the rotor body (4), or are each configured as a separate pole body.

10. The rotor according to claim 1, wherein rotor carrier (3) is a rotor shaft, wherein the rotor shaft (3) is a hollow shaft comprising a shaft cooling channel (20), wherein the respective cooling channel (15) of the rotor body (4) is connected to a flow through the shaft cooling channel (20) via the respective breaker slot (16) and a radial opening (21) of the rotor shaft (3).

11. The rotor according to claim 1, wherein the rotor sleeve (5) is a fiber winding and a cured composite material for embedding the fiber winding.

12. An electric machine with a rotor (1) according to claim 1.

13. The rotor according to claim 1, wherein the rotor sleeve (5) is fiber composite sleeve.

14. The rotor according to claim 1, wherein in all of the rotor poles (7) a V-shaped, C-shaped or arc-shaped magnetic layer (8) of a plurality of magnets (9) is formed.

15. The rotor according to claim 1, wherein the plurality of magnets (9) are permanent magnets.

16. The rotor according to claim 1, wherein the central area (12.1) lies in an area of the pole center (7.1) and is configured as a bridge.

17. The rotor according to claim 1, wherein the rotor sleeve (5) is pre-tensioned for clamping the magnets (9) into the magnetic pockets (12).

18. The rotor according to claim 1, wherein the pre-tensioning of the rotor sleeve (5) is generated or increased by pressing the rotor carrier (3) into the inner passage (6) of the rotor body (4).

19. The rotor according to claim 5, wherein the extension of the respective cooling channel (15) extends radially inward in a circumferential direction because a cross section of the cooling channel (15) is formed in a triangular, V, trapezoidal, or bell shape.

20. The rotor according to claim 11, wherein the fiber winding includes glass fibers or carbon fibers.
